(19) United States
(12) Patent Application Publication
(10) Pub. No.: US 2016/0370678 A1
(43) Pub. Date: Dec. 22, 2016

(54) LIQUID CRYSTAL DISPLAY DEVICE AND PRODUCTION METHOD THEREOF

(71) Applicant: Panasonic Liquid Crystal Display Co., Ltd., Hyogo (JP)

(72) Inventor: Kikuo ONO, Ibaraki (JP)

(21) Appl. No.: 15/255,339

(22) Filed: Sep. 2, 2016

Related U.S. Application Data
(63) Continuation of application No. PCT/JP2014/001225, filed on Mar. 5, 2014.

(51) Int. Cl. G02F 1/1362; G02F 1/1333; G02F 1/1368; G02F 1/1343

(52) U.S. Cl. CPC G02F 1/136286; G02F 1/134336; G02F 1/133345; G02F 1/136227; G02F 1/1368; G02F 1/13439; G02F 2201/121; G02F 2201/123; G02F 2001/136295

(57) ABSTRACT

A liquid crystal display device includes a first substrate, a second substrate, a liquid crystal layer interposed between the first substrate and the second substrate, signal lines, data signal lines, pixel electrodes, a common electrode, and capacitance electrodes formed on the second substrate. The common electrode is disposed between the pixel electrodes and the second substrate. The capacitance electrodes are disposed between the common electrode and the second substrate. In each of the pixels, a capacitance electrode of the capacitance electrodes is electrically connected to a pixel electrode of the pixel electrodes disposed corresponding to the pixel. At least a part of each of the capacitance electrodes overlaps a next-scanned gate signal line of the gate signal lines that is associated with an adjacent pixel of the pixels in plan view. The data signal lines and the capacitance electrodes overlap the common electrode in plan view.

### CROSS-REFERENCE TO RELATED APPLICATION

This application is a bypass continuation of international patent application PCT/JP2014/001225, filed: Mar. 5, 2014 designating the United States of America, the entire disclosure of which is incorporated herein by reference in its entirety.

### TECHNICAL FIELD

The present disclosure relates to a liquid crystal display device and a production method thereof.

### BACKGROUND

In the liquid crystal display device, an electric field generated between a pixel electrode formed in each pixel region and a common electrode is applied to liquid crystal to drive the liquid crystal, whereby a quantity of light transmitted through a region between the pixel electrode and the common electrode is adjusted to display an image. A thin film transistor is formed near an intersection point of a gate signal line and a data signal line in each pixel region.

Conventionally, in the liquid crystal display device, there is a problem in that a pixel potential fluctuates by a jumping voltage (pull-in voltage) generated during a fall of a gate signal (scan signal) due to a parasitic capacitance generated between the thin film transistor and the gate signal line. For example, the prior art discloses a technique for solving the problem (See Japanese Unexamined Patent Application Publication No. S59-119390).

The technique disclosed in the prior art compensates for the jumping voltage by forming a capacitance (additional capacitance) corresponding to the parasitic capacitance generated at a current stage between a current-stage pixel electrode and a next-stage gate signal line to be scanned next.

However, in the technique disclosed in the prior art, display unevenness caused by the parasitic capacitance generated between the pixel electrode and the data signal line is hardly reduced although display unevenness caused by the parasitic capacitance between the thin film transistor and the gate signal line can be reduced. Specifically, in each pixel region, the parasitic capacitance is generated between the pixel electrode and the two data signal lines adjacent to the pixel electrode. For large parasitic capacitance, there is a known problem in that the display unevenness emerges by generating a crosstalk. The generation of the crosstalk is hardly reduced by the technique disclosed in the prior art.

### SUMMARY

An object of the present disclosure is to provide a liquid crystal display device and a production method thereof, that are able to reduce the display unevenness caused by the parasitic capacitances generated in the gate signal line and data signal line.

In one general aspect, a liquid crystal display device includes a first substrate on a surface side, a second substrate on a rear side, a liquid crystal layer interposed between the first substrate and the second substrate, a plurality of gate signal lines, a plurality of data signal lines, a plurality of pixel electrodes, a common electrode, and a plurality of capacitance electrodes formed on the second substrate. The plurality of gate signal lines extend in a row direction, the plurality of data signal lines extend in a column direction, the plurality of pixel electrodes correspond to a plurality of pixels arrayed in the row and column directions, the common electrode is disposed between the plurality of pixel electrodes and the second substrate, the plurality of capacitance electrodes are disposed between the common electrode and the second substrate, in each of the plurality of pixels, a capacitance electrode of the capacitance electrodes is electrically connected to a pixel electrode of the pixel electrodes disposed corresponding to the pixel. At least a part of each of the capacitance electrodes overlaps a next-scanned gate signal line of the gate signal lines that is associated with an adjacent pixel of the pixels in plan view. The plurality of data signal lines and the plurality of capacitance electrodes overlap the common electrode in plan view.

The above general aspect may include one or more of the following features. The liquid crystal display device may include a first insulating film covering the plurality of gate signal lines and being interposed between the gate signal lines and the capacitance electrodes.

The liquid crystal display device may further include a second insulating film; and a third insulating film. The plurality of data signal lines and the plurality of capacitance electrodes may be formed in a same layer. The common electrode overlaps the plurality of data signal lines and the plurality of capacitance electrodes with the second insulating film being interposed therebetween. The plurality of pixel electrodes overlap the common electrode with the third insulating film being interposed therebetween.

In each of the plurality of pixels, the capacitance electrode may be electrically connected to the pixel electrode corresponding to the pixel through a contact hole made in the second and third insulating films.

In each of the plurality of pixels, the capacitance electrode may be disposed between an adjacent pair of the data signal lines, and extends in the column direction.

In each of the plurality of pixels, a width of the capacitance electrode in the row direction may be smaller than a distance between the capacitance electrode and a data signal line of the data signal lines that is adjacent to the capacitance electrode.

In each of the plurality of pixels, the capacitance electrode may overlap the next-scanned gate signal line that is associated with the adjacent pixel so as to extend beyond at least part of the next-scanned gate signal line in the column direction in plan view.

The liquid crystal display device may further include a plurality of thin film transistors, each having a conduction electrode, that are disposed near intersection points of the pluralities of data signal lines and gate signal lines. In each of the plurality of pixels, the conduction electrode of a thin film transistor of the thin film transistors corresponding to the pixel may extend to form the capacitance electrode.

The liquid crystal display device may further include a plurality of thin film transistors, each having a conduction electrode, that are disposed near intersection points of the pluralities of data signal lines and gate signal lines. In each of the plurality of pixels, the capacitance electrode may be electrically connected to the conduction electrode of a thin film transistor of the thin film transistors corresponding to the pixel.

The plurality of capacitance electrodes may be made of a transparent conductive material.

The liquid crystal display device may further include a plurality of thin film transistors, each having a conduction electrode, that are disposed near intersection points of the pluralities of data signal lines and gate signal lines. In plan view, each of the plurality of gate signal lines may include a notch, a first projection, and a second projection in each of the plurality of pixels, the notch accommodating a contact hole therein, the first and second projections being disposed in the row direction while facing each other with the notch being interposed therebetween. In each of the plurality of pixels, the conduction electrode of a thin film transistor of the thin film transistors may overlap the first and second projections while extending over the notch in plan view.

In another general aspect, a liquid crystal display device production method includes the steps of forming a gate signal line on a substrate, forming a first insulating film to cover the gate signal line, forming a data signal line on the first insulating film, forming a capacitance electrode on the first insulating film such that at least a part of the capacitance electrode overlaps the gate signal line that is adjacent in a scan direction in plan view, forming a second insulating film to cover the data signal line and the capacitance electrode, forming a common electrode on the second insulating film, forming a third insulating film to cover the common electrode, forming a contact hole in the second and third insulating films; and forming a pixel electrode on the third insulating film and in the contact hole.

The configuration of the liquid crystal display device according to the present disclosure can reduce the display unevenness caused by the parasitic capacitances generated in the gate signal line and data signal line.

### BRIEF DESCRIPTION OF DRAWINGS

FIG. 1 is a view illustrating an entire configuration of a liquid crystal display device according to a first exemplary embodiment;

FIG. 2 is a plan view illustrating a configuration of one pixel in the liquid crystal display panel of the first exemplary embodiment;

FIG. 3 is a sectional view taken along a line 3-3′ of FIG. 2;

FIG. 4 is a sectional view taken along a line 4-4′ of FIG. 2;

FIG. 5A is an equivalent circuit diagram illustrating the capacitances formed in the pixel;

FIG. 5B is a timing chart illustrating various signals associated with a pixel;

FIG. 6A is a timing chart illustrating various signals associated with a conventional pixel;

FIG. 6B is a display image in a conventional display illustrating a crosstalk;

FIG. 7A is a timing chart illustrating various signals associated with the pixel according to the first exemplary embodiment;

FIG. 7B is a display image in a display according to the first exemplary embodiment;

FIG. 8A is a plan view illustrating one pixel after a first photo-etching process;

FIG. 8B is a sectional view taken along a line b-b′ of FIG. 8A;

FIG. 9A is a plan view illustrating one pixel after a second photo-etching process;

FIG. 9B is a sectional view taken along a line b-b′ of FIG. 9A;

FIG. 10A is a plan view illustrating one pixel after a second photo-etching process;

FIG. 10B is a sectional view taken along a line b-b′ of FIG. 10A;

FIG. 11A is a plan view illustrating one pixel after a third photo-etching process;

FIG. 11B is a sectional view taken along a line b-b′ of FIG. 11A;

FIG. 12A is a plan view illustrating one pixel after a fourth photo-etching process;

FIG. 12B is a sectional view taken along a line b-b′ of FIG. 12A;

FIG. 13A is a plan view illustrating one pixel after a fifth photo-etching process;

FIG. 13B is a sectional view taken along a line b-b′ of FIG. 13A;

FIG. 14A is a plan view illustrating one pixel after a sixth photo-etching process;

FIG. 14B is a sectional view taken along a line b-b′ of FIG. 13A;

FIG. 15 is a plan view illustrating a configuration of one pixel in the liquid crystal display panel of a second exemplary embodiment;

FIG. 16 is a sectional view taken along a line 16-16′ of FIG. 15;

FIG. 17 is a sectional view taken along a line 17-17′ of FIG. 15;

FIG. 18 is a plan view illustrating a configuration of one pixel in the liquid crystal display panel of a third exemplary embodiment;

FIG. 19 is a sectional view taken along a line 19-19′ of FIG. 18;

FIG. 20 is a sectional view taken along a line 20-20′ of FIG. 18;

FIG. 21 is a plan view illustrating a modified configuration of one pixel in the liquid crystal display panel of the third exemplary embodiment.

### DETAILED DESCRIPTION

Hereinafter, an exemplary embodiment of the present disclosure will be described with reference to the drawings.

### First Exemplary Embodiment

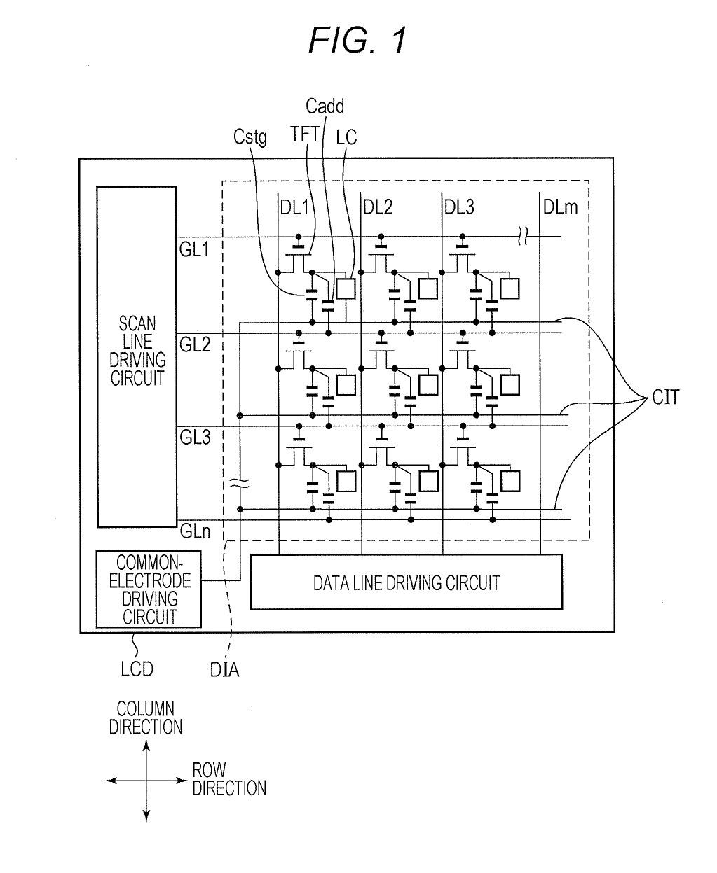

FIG. 1 is a view illustrating an entire configuration of a liquid crystal display device according to a first exemplary embodiment. A liquid crystal display device LCD includes an image display region DIA and a driving circuit region for driving the image display region DIA. In the image display region DIA, pixel regions each of which is surrounded by gate signal lines GL adjacent to each other and data signal lines DL adjacent to each other are arrayed into a matrix shape in a row and column directions. It is assumed that the row direction is a direction in which the gate signal lines GL extend, and that the column direction is a direction in which the data signal lines DL extend.

Active matrix display is performed in each pixel region. Specifically, a gate voltage is supplied from a scan line driving circuit to gate signal lines (_{scan} lines) GL1, GL2, . . . , and GLn, a data voltage is supplied from a data line driving circuit to data signal lines DL1, DL2, . . . , and DLm, and a common voltage is supplied from a common-electrode driving circuit to a transparent common electrode CIT. The gate voltage turns on and off a thin film transistor TFT, thereby supplying the data voltage to a transparent pixel electrode PIT. A liquid crystal layer LC is driven by an electric field, which is generated by a difference between the data voltage supplied to the transparent pixel electrode PIT and the common voltage supplied to the transparent common electrode CIT, whereby a transmittance of light is controlled to display an image. Desired data voltages are applied to data signal lines DL1(R), DL2(G), and DL3(B) connected to the transparent pixel electrodes PIT in the pixel regions, which are formed by a vertically-stripe-pattern color filters to correspond to red (R), green (G), and blue (B), thereby performing color display.

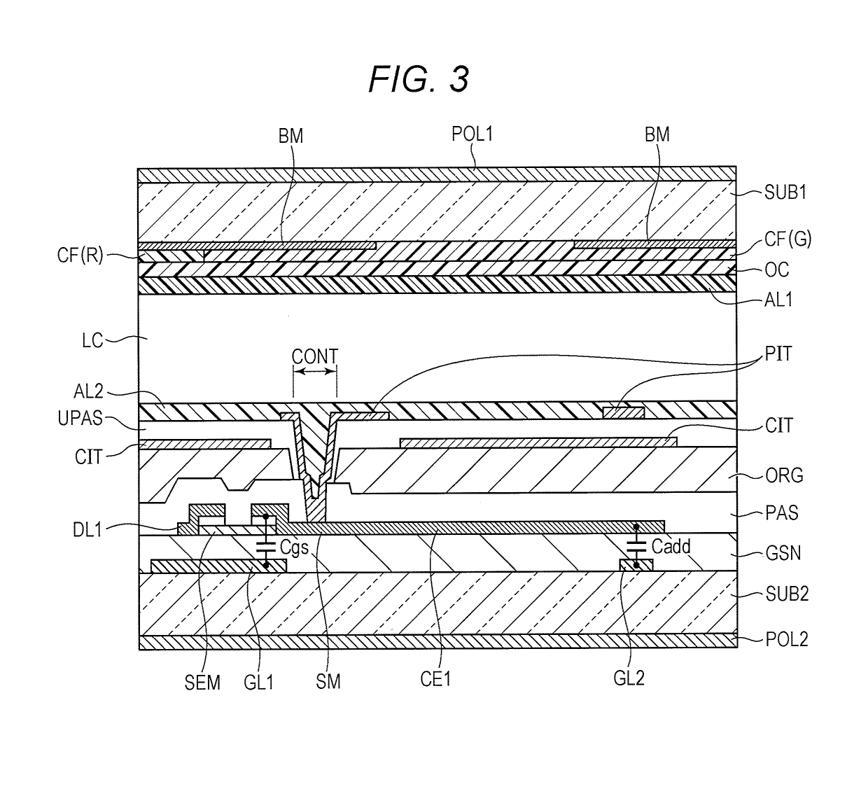

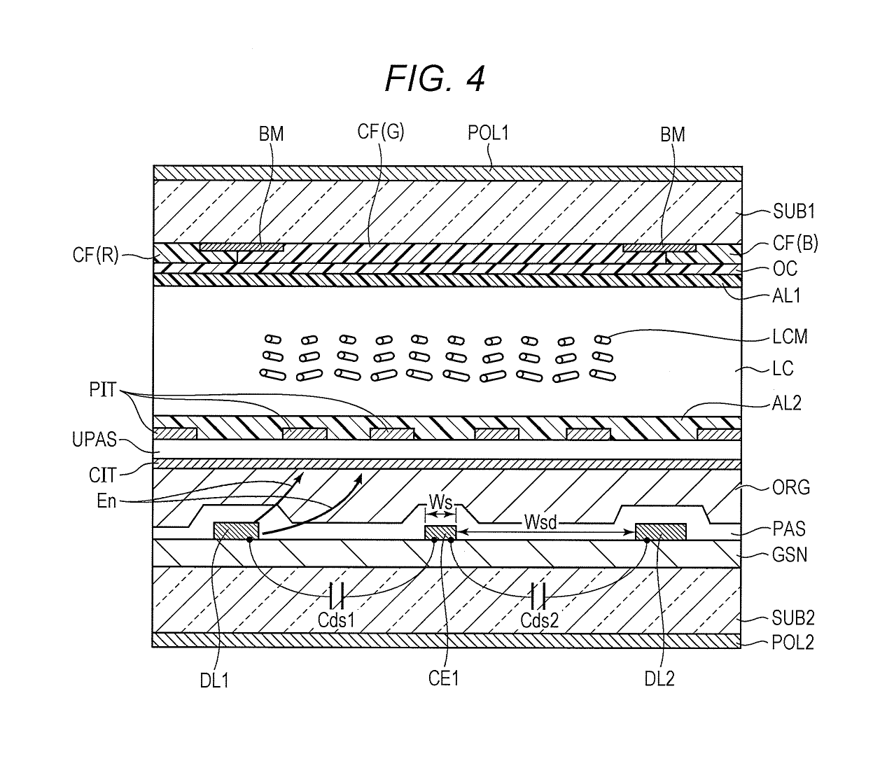

A holding capacitance Cstg is formed in each pixel region in order to prevent a voltage drop in the liquid crystal layer LC. The holding capacitance Cstg is formed in a region where the transparent pixel electrode PIT and the transparent common electrode CIT overlap each other with an insulating film (upper insulating film UPAS) being interposed therebetween (refer to FIGS. 3 and 4). The common voltage is supplied from the common-electrode driving circuit to the transparent common electrode CIT disposed in the image display region DIA.

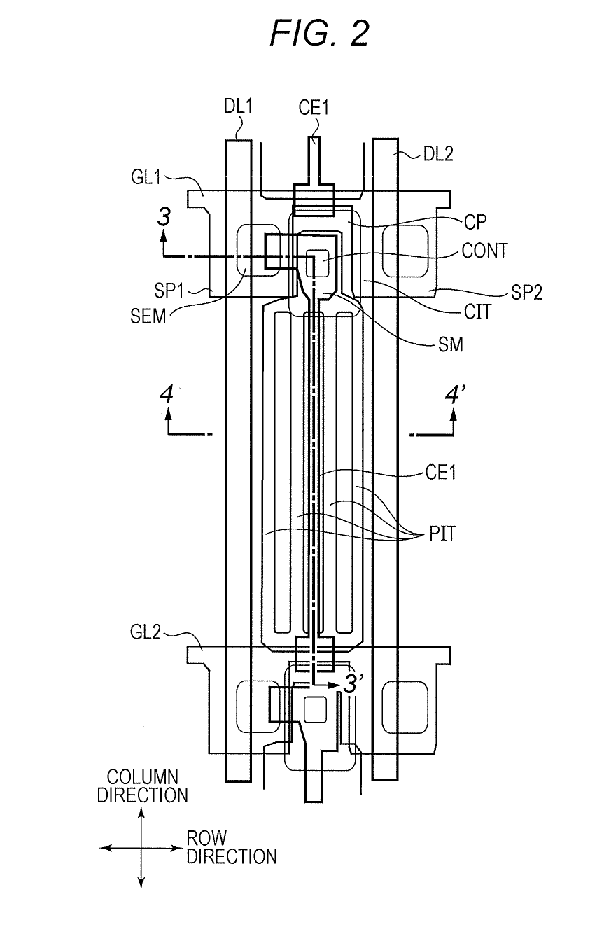

FIG. 2 is a plan view illustrating a configuration of one pixel in the liquid crystal display panel of the first exemplary embodiment. FIG. 2 illustrates the pixel region surrounded by the gate signal lines GL1 and GL2 adjacent to each other and the data signal lines DL1 and DL2 adjacent to each other.

In plan view, the transparent pixel electrode PIT is formed in a region surrounded by the (current-stage) gate signal line GL1 for driving the pixel, the (next-stage) gate signal line GL2 to be scanned next, and the data signal lines DL1 and DL2 adjacent to each other. A slit (opening) is formed in the transparent pixel electrode PIT. There is no particular limitation to a shape of the slit. For example, the slit may be formed with a long and thin shape or a general opening such as a rectangular shape or an elliptical shape. A width of the slit may be larger or smaller than a distance between the slits adjacent to each other.

The transparent pixel electrode PIT is electrically connected to a source electrode SM (conduction electrode) of the thin film transistor TFT through a contact hole CONT.

The transparent common electrode CIT is formed into a flat shape in the whole image display region DIA. In each pixel region of the transparent common electrode CIT, an opening is formed in a region where the contact hole CONT and a part (source electrode) of the thin film transistor TFT are formed in plan view.

Each gate signal line GL includes a notch CP, a projection SP1 (first projection), and a projection SP2 (second projection). In plan view, the notch CP is disposed in the region where the contact hole CONT and the part (source electrode) of the thin film transistor TFT are formed, and the projection SP1 (first projection) and the projection SP2 (second projection) are disposed while facing each other in the row direction with the notch CP being interposed therebetween.

A capacitance electrode CE1 is disposed between (particularly, near a center of) the data signal lines DL1 and DL2 adjacent to each other, and extends in the column direction. The source electrode SM of the thin film transistor TFT extends in the column direction to form the capacitance electrode CE1. The capacitance electrode CE1 is electrically connected to the transparent pixel electrode PIT through the contact hole CONT. A part (end portion) of the capacitance electrode CE1 overlaps the next-stage gate signal line GL2 in plan view. The width in the row direction of the capacitance electrode CE1 is smaller than the distance between the end portion of the capacitance electrode CE1 and each of the data signal lines DL1 and DL2.

A sectional structure of the pixel will be described below. FIG. 3 is a sectional view taken along a line 3-3′ of FIG. 2. FIG. 4 is a sectional view taken along a line 4-4′ of FIG. 2.

The liquid crystal layer LC is sandwiched between a surface-side first transparent substrate SUB1 (first substrate) and a rear-side second transparent substrate SUB2 (second substrate), which are of two transparent substrates. Positive-type liquid crystal molecules LCM (refer to FIG. 4) in which major axes are aligned along an electric field direction are sealed in the liquid crystal layer LC.

A first polarizing plate POL1 and a second polarizing plate POL2 are bonded to outsides of the first transparent substrate SUB1 and second transparent substrate SUB2, respectively. A known configuration can be used in the first and second polarizing plates POL1 and POL2. A first alignment film AL1 on surface side and a second alignment film AL2 on rear-side are formed in the liquid crystal layer LC. The liquid crystal molecules LCM can be fixed by the first alignment film AL1 and the second alignment film AL2. A known configuration can be used in the alignment film AL. The surface of a color filter CF is coated with an overcoat film OC made of an organic material.

When a semiconductor layer SEM is directly irradiated with external light, a resistance of the semiconductor layer SEM decreases to degrade a holding property of the liquid crystal display device LCD, which results in a risk that a good image is not displayed. For this reason, in the first transparent substrate SUB 1, a black matrix BM is formed above the semiconductor layer SEM. In the color filter CF, the black matrix BM is also disposed at a boundary between the pixels. Therefore, color mixture caused by obliquely viewing the pieces of light of the pixels adjacent to each other is prevented to obtain a large advantageous effect that the image can be displayed without a blur. At the same time, an aperture or a transmittance is degraded when the width of the black matrix BM is excessively large. In order to obtain the bright, low-power-consumption performance in the high-resolution liquid crystal display device, preferably the width of the black matrix BM is set to the minimum width of a degree at which the color mixture is not generated when the display device is viewed from an oblique viewing angle. The black matrix BM is made of a resin material in which black pigment is used or is made of a metallic material.

The gate signal lines GL are formed by a metallic material mainly containing aluminum (Al), molybdenum (Mo), titanium (Ti), or copper (Cu), a plurality of laminated layers thereof, an alloy in which tungsten (W), manganese (Mn), or titanium (Ti) is added to the metallic material, or a laminated metallic layer of a combination thereof.

A gate insulating film GSN (first insulating film) is formed so as to cover the gate signal lines GL. The gate insulating film GSN can be made of a known material.

The semiconductor layer SEM is formed on the gate insulating film GSN, and the data signal line DL1 and the source electrode SM of the thin film transistor TFT are formed on the semiconductor layer SEM. The source electrode SM extends on the gate insulating film GSN, and constitutes the capacitance electrode CE1 on the gate insulating film GSN. The capacitance electrode CE 1 extends in the column direction on the gate insulating film GSN, and the end portion of the capacitance electrode CE1 overlaps the gate signal line GL2 with the gate insulating film GSN being interposed therebetween. As illustrated in FIG. 4, a width Ws in the row direction of the capacitance electrode CE1 is smaller than a distance Wsd between the end portion of the capacitance electrode CE1 and each of the data signal lines DL1 and DL2 (Ws<Wsd). Preferably the distance Wsd is larger than or equal to twice the width Ws (2×Ws<Wsd). Preferably the capacitance electrode CE1 is disposed equidistant between the data signal lines DL1 and DL2 in the row direction. Therefore, the distance between the data signal lines DL1 and DL2 and the capacitance electrode CE1 can be increased.

A protective insulating film PAS is formed so as to cover the data signal line DL1, the source electrode SM, and the capacitance electrode CE1. The protective insulating film PAS can be made of silicon nitride (SiN) or silicon dioxide (SiO₂). The protective insulating film PAS may be eliminated.

An inter-layer insulating film ORG (an organic protective film, a second insulating film) is formed on the protective insulating film PAS. The inter-layer insulating film ORG is made of a photosensitive organic material mainly containing acryl. An organic material has a dielectric constant of 4 or less, which is lower than a dielectric constant of 6.7 of silicon nitride. For the viewpoint of production, an organic material can be deposited thicker than silicon nitride. For example, the inter-layer insulating film ORG is set to thicknesses of 1.5 μm to 3 μm. The inter-layer insulating film ORG can be set to a larger thickness while set to the lower dielectric constant, so that a wiring capacitance formed between the transparent common electrode CIT disposed on the inter-layer insulating film ORG and the data signal line DL or gate signal line GL can largely be reduced.

The transparent common electrode CIT is formed on the inter-layer insulating film ORG. The transparent common electrode CIT is made of a transparent electrode material. Indium tin oxide or indium zinc oxide is used as the transparent electrode material. Each pixel region is covered with the transparent common electrode CIT except for the region where the thin film transistor TFT is formed. That is, the transparent common electrode CIT covers the data signal line DL and the capacitance electrode CE1 to act as a shield electrode. Therefore, for example, an electric field noise En (refer to FIG. 4) generated from the data signal line DL can be prevented from invading in the liquid crystal layer LC.

The upper insulating film UPAS (third insulating film) is formed so as to cover the transparent common electrode CIT. The upper insulating film UPAS can be made of a known material.

The transparent pixel electrode PIT is formed on the upper insulating film UPAS. The transparent pixel electrode PIT is made of a transparent electrode material (ITO). The transparent pixel electrode PIT is electrically connected to the source electrode SM through the contact hole CONT formed in the protective insulating film PAS, the inter-layer insulating film ORG and the upper insulating film UPAS.

A method for driving the liquid crystal display device LCD will briefly be described. The gate signal line GL is formed by the low-resistance metallic layer, and the scanning gate voltage is applied to the gate signal line GL from the scan line driving circuit. The data signal line DL is formed by the low-resistance metallic layer, and the video data voltage is applied to the data signal line DL from the data line driving circuit. When a gate-on voltage is applied to the gate signal line GL, the semiconductor layer SEM of the thin film transistor TFT enters a low-resistant state, the data voltage applied to the data signal line DL is transmitted to the transparent pixel electrode PIT through the source electrode SM that is formed by the low-resistance metallic layer and electrically connected to the transparent pixel electrode PIT.

The common voltage is applied to the transparent common electrode CIT from the common-electrode driving circuit. The transparent common electrode CIT overlaps the transparent pixel electrode PIT with the upper insulating film UPAS being interposed therebetween. The slit (opening) is formed in the transparent pixel electrode PIT. The liquid crystal layer LC is driven by a driving electric field, which reaches the transparent common electrode CIT from the transparent pixel electrode PIT through the liquid crystal layer LC, through the slit of the transparent pixel electrode PIT, whereby the image is displayed.

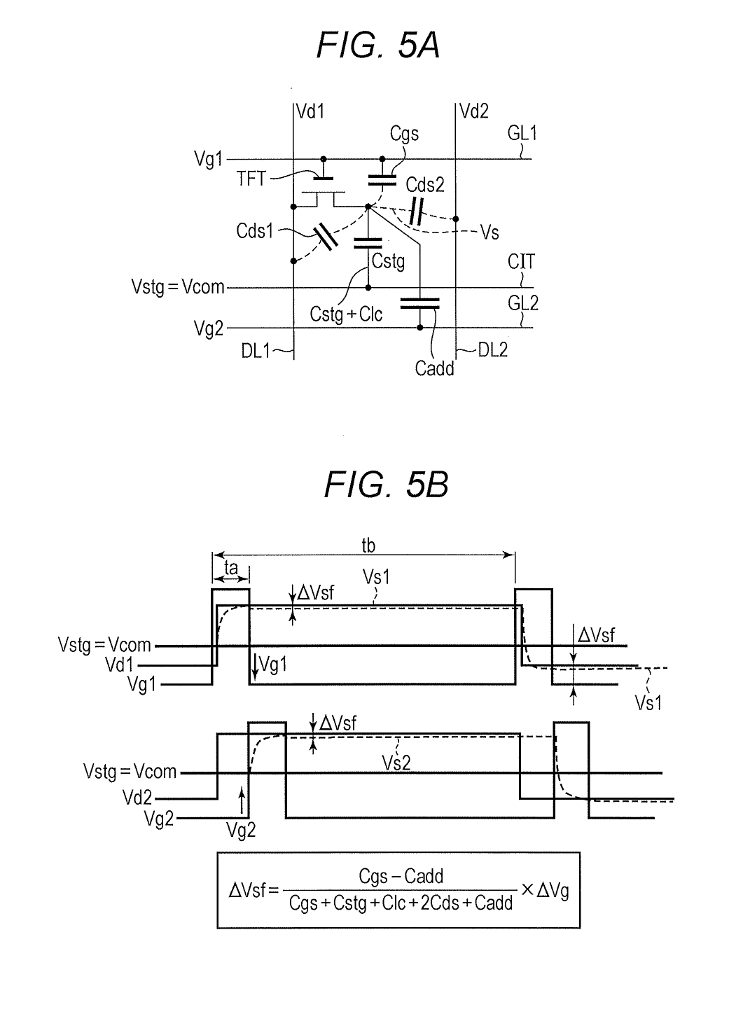

In the pixel configuration, various capacitances are formed in the pixel region. FIGS. 1, 3, and 4 illustrate the capacitances formed in the pixel. FIG. 5A is an equivalent circuit diagram illustrating the capacitances formed in the pixel.

A liquid crystal capacitance Clc and a holding capacitance Cstg are formed between the transparent pixel electrode PIT and the transparent common electrode CIT. A parasitic capacitance Cds1 is formed between the transparent pixel electrode PIT and the data signal line DL1, and a parasitic capacitance Cds2 is formed between the transparent pixel electrode PIT and the data signal line DL2. A parasitic capacitance Cgst is formed between the source electrode SM of the thin film transistor TFT and the gate signal line GL1, and a parasitic capacitance Cgsi is formed between the transparent pixel electrode PIT and the gate signal line GL1. FIG. 5A illustrates a capacitance Cgs of a sum of the parasitic capacitance Cgst and the parasitic capacitance Cgsi. An additional capacitance Cadd is formed between the capacitance electrode CE1 and the gate signal line GL2.

At this point, because the capacitance Cgs is formed between the gate signal line GL1, and both the source electrode SM of the thin film transistor TFT and the transparent pixel electrode PIT connected to the source electrode SM, conventionally a jumping voltage ΔVsf (pull-in voltage) is generated during the fall (off) of a gate voltage Vg1, which results in the problem in that a pixel potential Vs1 decreases. On the other hand, in the exemplary embodiment, the pixel potential Vs1 increases during a rise (on) of a gate voltage Vg2 because the additional capacitance Cadd is formed between the capacitance electrode CE1 electrically connected to the transparent pixel electrode PIT and the next-stage gate signal line GL2. A rise quantity of the pixel potential is correlated with the capacitance value of the additional capacitance Cadd. The capacitance value of the additional capacitance Cadd is correlated with an overlapping area of the capacitance electrode CE1 and the gate signal line GL2. Therefore, in order to suppress a potential fluctuation (decrease in pixel potential) caused by the capacitance Cgs, preferably the overlapping area of the capacitance electrode CE1 and the gate signal line GL2 is set such that the capacitance Cgs and the additional capacitance Cadd are substantially equal to each other.

FIG. 5B is a timing chart illustrating various signals associated with the pixel. As illustrated in FIG. 5B, for the pixel potential Vs1 at the pixel, the jumping voltage ΔVsf is decreased or substantially canceled by the gate voltage Vg2 that rises at the same time as the fall of the gate voltage Vg1. Therefore, the potential fluctuation of the pixel potential Vs1 can be suppressed.

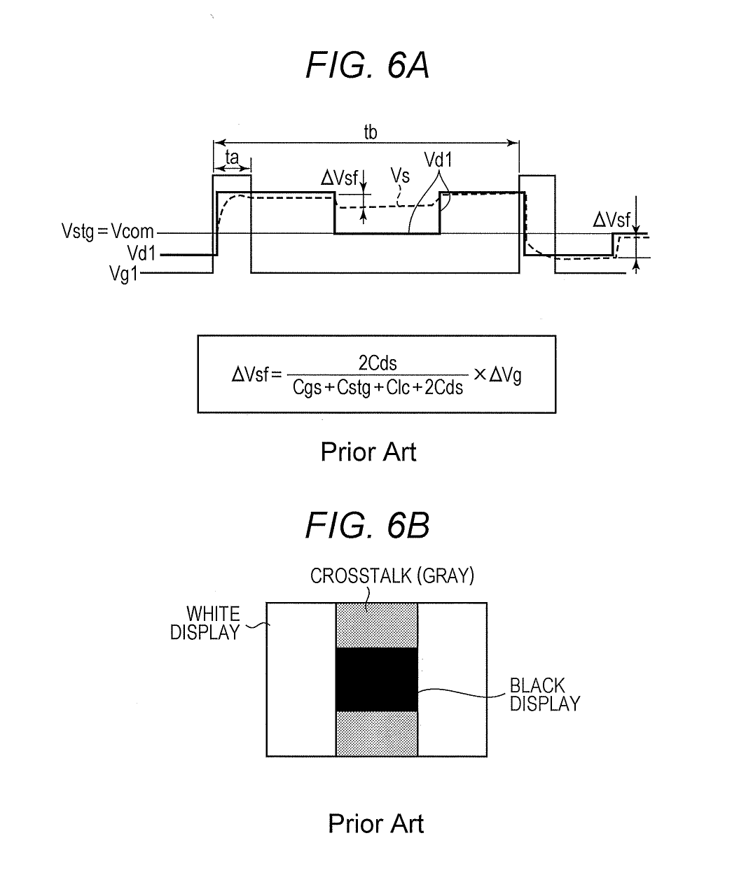

Conventionally, the parasitic capacitances Cds1 and Cds2 formed between the transparent pixel electrode PIT and the data signal lines DL1 and DL2, respectively, are one of the factors that generates the crosstalk (vertical crosstalk) in a vertical direction (column direction). For example, in the conventional liquid crystal display device, when the image including a black region and a white region surrounding the black region is displayed while the parasitic capacitances Cds1 and Cds2 have the large capacitance values, the jumping voltage ΔVsf increases and the pixel potential Vs fluctuates (decreases) as illustrated in FIG. 6A. Therefore, as illustrated in FIG. 6B, the crosstalk is generated above and below the black region, and therefore the image looks gray. Particularly, this phenomenon becomes conspicuous in frame inversion drive.

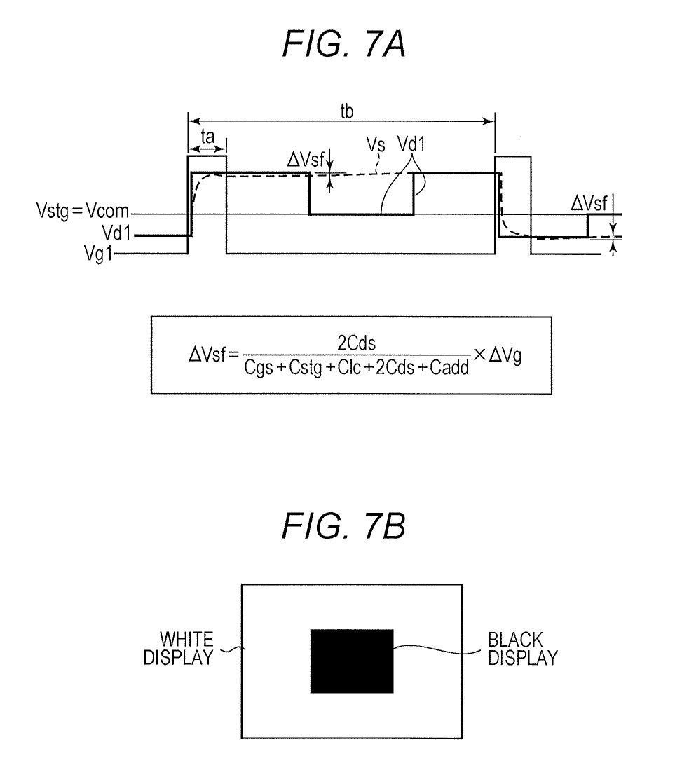

On the other hand, in the exemplary embodiment, the data signal line DL is shielded by the transparent common electrode CIT, and the capacitance electrode CE1 is disposed near the center of the pixel region and largely separated from the data signal line DL. For this reason, the capacitance values of the parasitic capacitances Cds1 and Cds2 can be decreased. As illustrated in FIG. 7A, the jumping voltage ΔVsf can be decreased, and the potential fluctuation of the pixel potential Vs can be suppressed. Therefore, as illustrated in FIG. 7B, the generation of the vertical crosstalk can be suppressed.

Thus, in the exemplary embodiment, the display unevenness caused by the parasitic capacitance Cgs generated in the gate signal line GL and the display unevenness caused by the parasitic capacitance Cds generated in the data signal line DL can simultaneously be reduced.

A method for producing the various layers on the second transparent substrate SUB2 (TFT substrate) in the liquid crystal display device LCD will be described below.

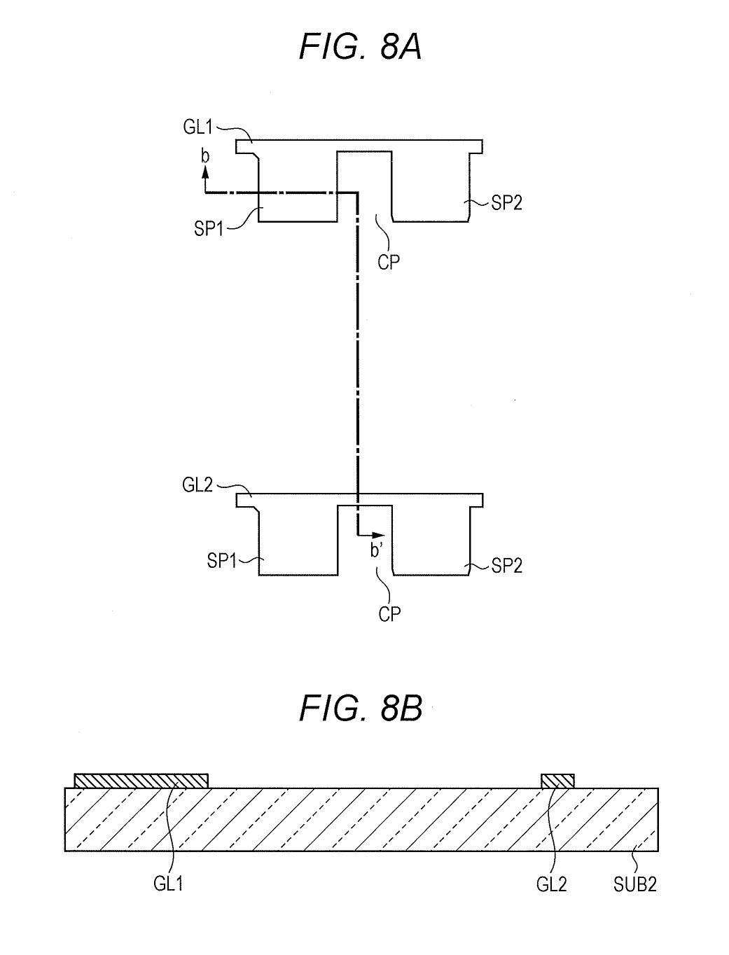

FIGS. 8A to 14B illustrate a process of producing the thin film transistor TFT, wiring region, and opening, which are formed on the second transparent substrate SUB2.

FIG. 8A is a plan view illustrating one pixel after a first photo-etching process, and FIG. 8B is a sectional view taken along a line b-b′ of FIG. 8A. In the first photo-etching process, a metallic material constituting the gate signal line GL is deposited on the glass substrate by sputtering, and patterned. Therefore, the gate signal line GL including the notch CP and projections SP1 and SP2 is formed as a planar pattern. For example, the metallic material is a laminated film including copper (Cu) having thickness of 100 nm to 300 nm and molybdenum (Mo) deposited thereon. Alternatively, a laminated film of molybdenum (Mo) and aluminum (Al), a laminated film of titanium (Ti) and aluminum (Al), or a MoW alloy of molybdenum (Mo) and tungsten (W) may be used as the metallic material.

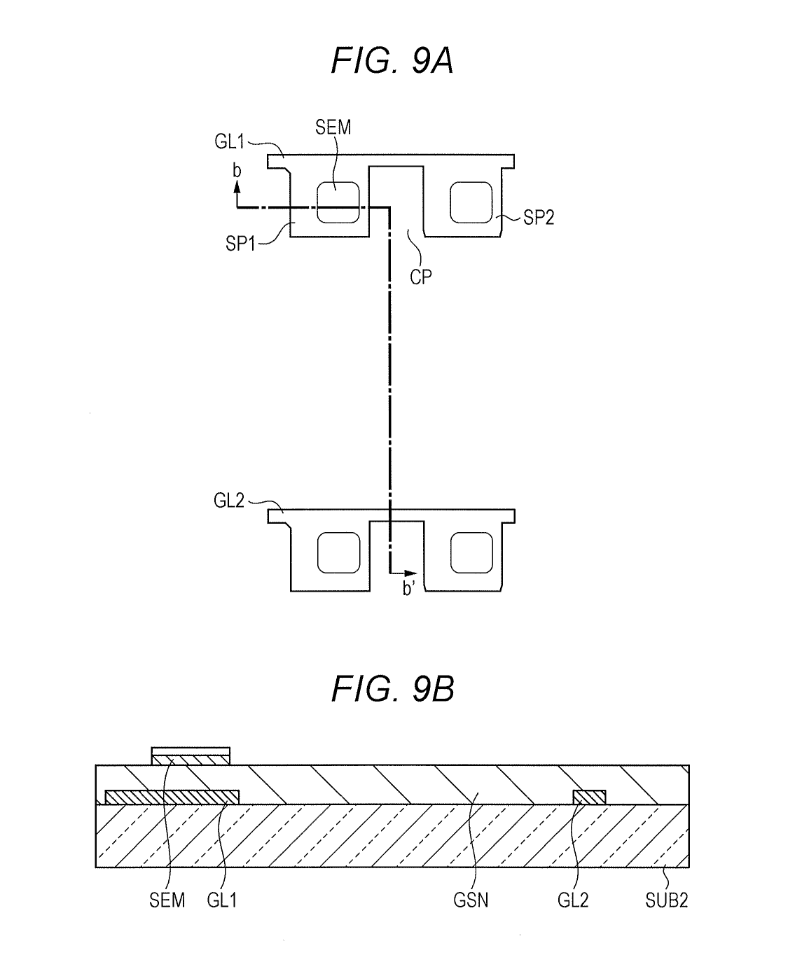

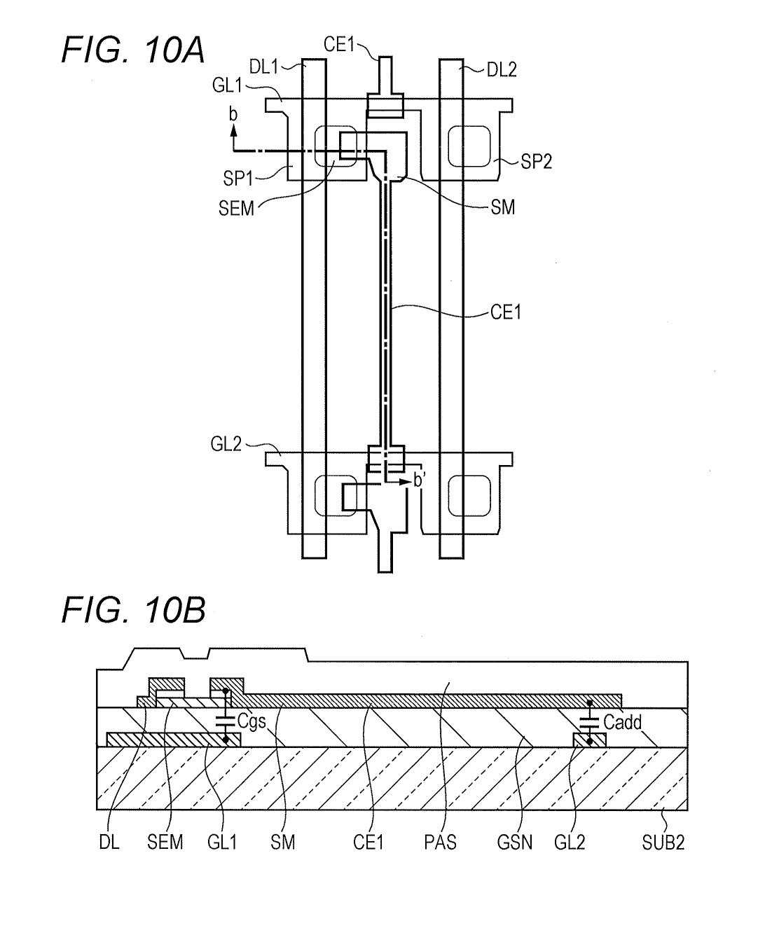

FIGS. 9A and 10A are plan views illustrating one pixel after a second photo-etching process, and FIGS. 9B and 10B are sectional views taken along lines b-b′ of FIGS. 9A and 10A. First, as illustrated in FIGS. 9A and 9B, by Chemical Vapor Deposition (CVD), the silicon-nitride gate insulating film GSN is deposited so as to cover the gate signal line GL, and the amorphous-silicon semiconductor layer SEM is laminated on the gate insulating film GSN. The laminated film of molybdenum (Mo) and copper (Cu) is deposited on the semiconductor layer SEM by sputtering.

As illustrated in FIGS. 10A and 10B, the data signal lines DL1 and DL2, the source electrode SM, and the capacitance electrode CE1 are simultaneously formed by half-tone exposure. At this point, the capacitance electrode CE1 is formed such that the end portion of the capacitance electrode CE1 overlaps the gate signal line GL2. The material used in the gate signal lines GL is similar to the material used in the metallic wiring. Then, the silicon-nitride protective insulating film PAS is laminated by chemical vapor deposition (CVD) so as to cover the data signal lines DL, the source electrode SM, and the capacitance electrode CE1.

The semiconductor layer SEM includes two layers, namely, a low-resistance semiconductor layer in which surface contains phosphorous and a low-impurity semiconductor layer. The low-resistance semiconductor layer of the semiconductor layer SEM is removed in a region of the thin film transistor TFT between the data signal line DL and the source electrode SM. In the semiconductor layer SEM, when an on voltage is applied to a gate electrode, electrons are induced at a boundary of the gate insulating film GSN, and a resistance is lowered to perform on operation.

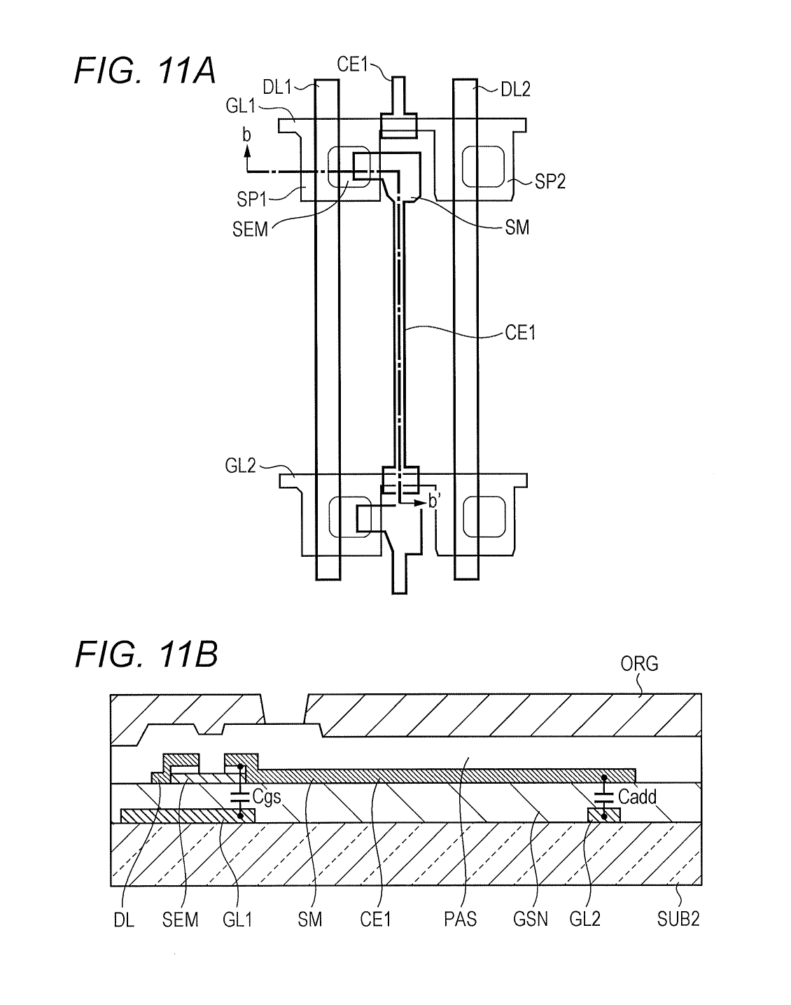

FIG. 11A is a plan view illustrating one pixel after a third photo-etching process, and FIG. 11B is a sectional view taken along a line b-b′ of FIG. 11A. In the third photo-etching process, the inter-layer insulating film ORG that is of photosensitive acryl is applied onto the protective insulating film PAS. The opening is formed in the inter-layer insulating film ORG located above the source electrode SM.

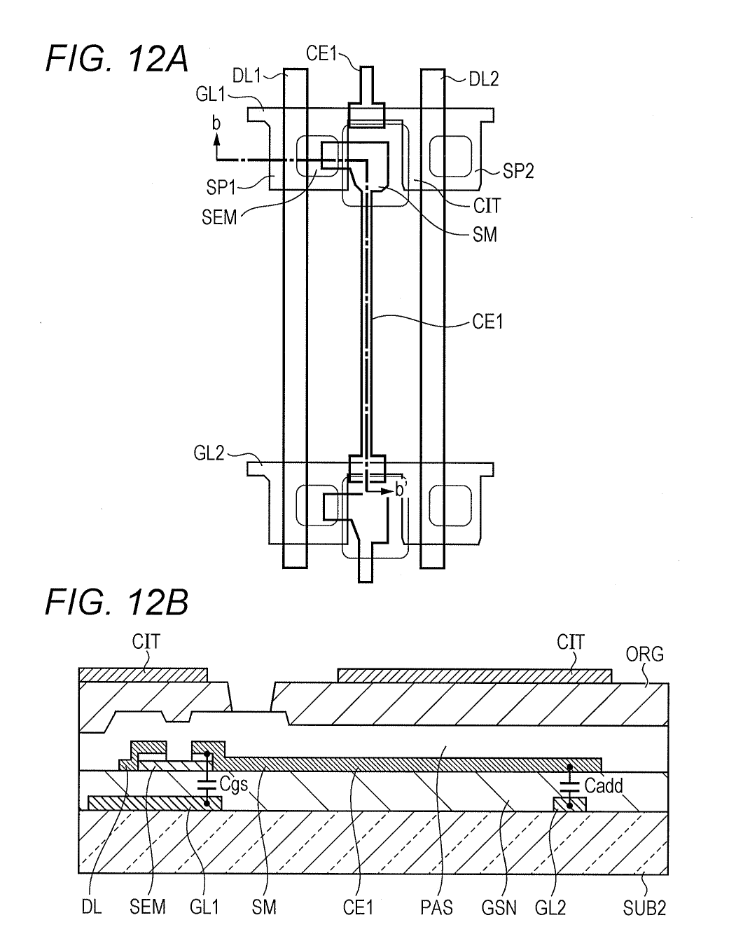

FIG. 12A is a plan view illustrating one pixel after a fourth photo-etching process, and FIG. 12B is a sectional view taken along a line b-b′ of FIG. 12A. In the fourth photo-etching process, the transparent common electrode CIT formed by a photo-etching process after indium tin oxide (ITO) is deposited on the inter-layer insulating film ORG.

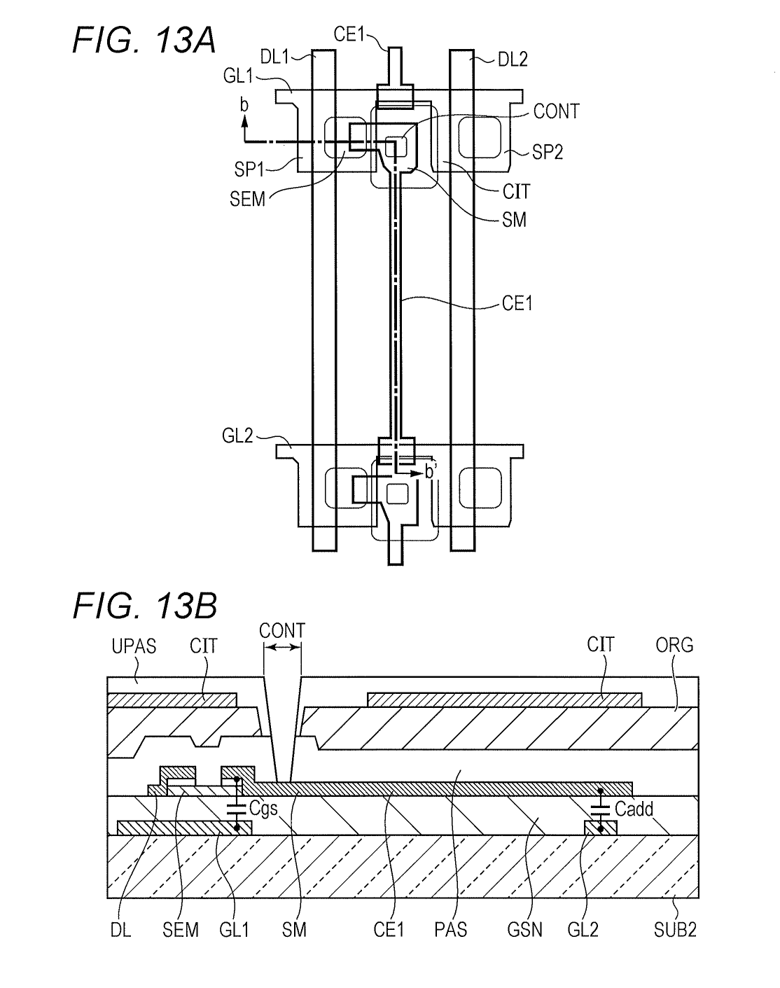

FIG. 13A is a plan view illustrating one pixel after a fifth photo-etching process, and FIG. 13B is a sectional view taken along a line b-b′ of FIG. 13A. In the fifth photo-etching process, the upper insulating film UPAS is formed by chemical vapor deposition (CVD) so as to cover the transparent common electrode CIT. The protective insulating film PAS and the upper insulating film UPAS are subjected to dry etching to form the contact hole CONT reaching the source electrode SM.

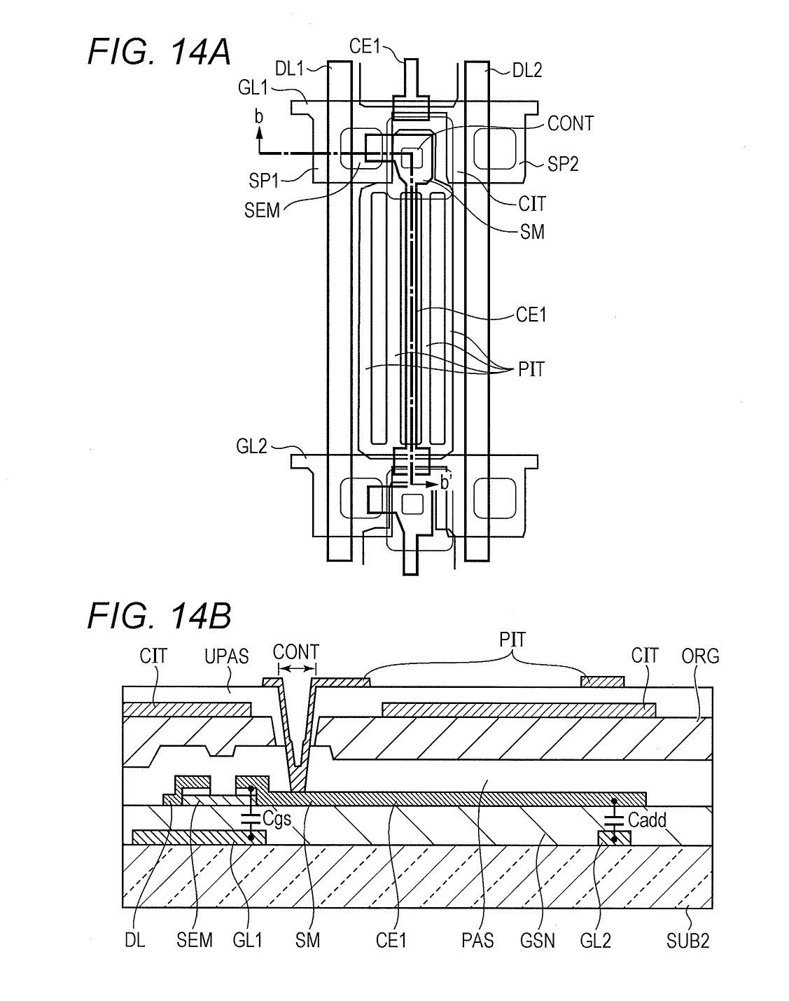

FIG. 14A is a plan view illustrating one pixel after a sixth photo-etching process, and FIG. 14B is a sectional view taken along a line b-b′ of FIG. 14A. In the sixth photo-etching process, indium tin oxide (ITO), which is a transparent electrode material, is deposited on the upper insulating film UPAS and in the contact hole CONT by sputtering, and the transparent pixel electrode PIT is formed by photo-etching. The transparent pixel electrode PIT is processed into a pattern including the slit. A part of the transparent pixel electrode PIT is directly deposited on the source electrode SM. Therefore, the transparent pixel electrode PIT, the source electrode SM, and the capacitance electrode CE1 are electrically connected to one another.

The layers on the second substrate SUB2 of the liquid crystal display device LCD are produced through the above-described steps of processing.

Preferably the capacitance electrode CE1 overlaps the next-stage gate signal line GL2 so as to extend over at least part of the next-stage gate signal line GL2 in the column direction in plan view. Specifically, as illustrated in FIG. 2, preferably the end portion of the capacitance electrode CE1 overlaps the gate signal line GL2 so as to protrude beyond the lower side of the gate signal line GL2. Even if the capacitance electrode CE1 deviates in the vertical direction (column direction) in the production process, the capacitance value of the additional capacitance Cadd can be kept constant because the area where the capacitance electrode CE1 and the gate signal line GL2 overlap each other does not fluctuate.

Preferably the portion (end portion in FIG. 2) overlapping the gate signal line GL2 has a larger width than other portions of the capacitance electrode CE1 in the row direction. Therefore, the capacitance value of the additional capacitance Cadd can be increased while the degradation of the aperture and transmittance is prevented.

### Second Exemplary Embodiment

A second exemplary embodiment of the present disclosure will be described below with reference to the drawings. For convenience, the components having the same functions as those of the first exemplary embodiment are designated by the same reference marks, and their description is omitted.

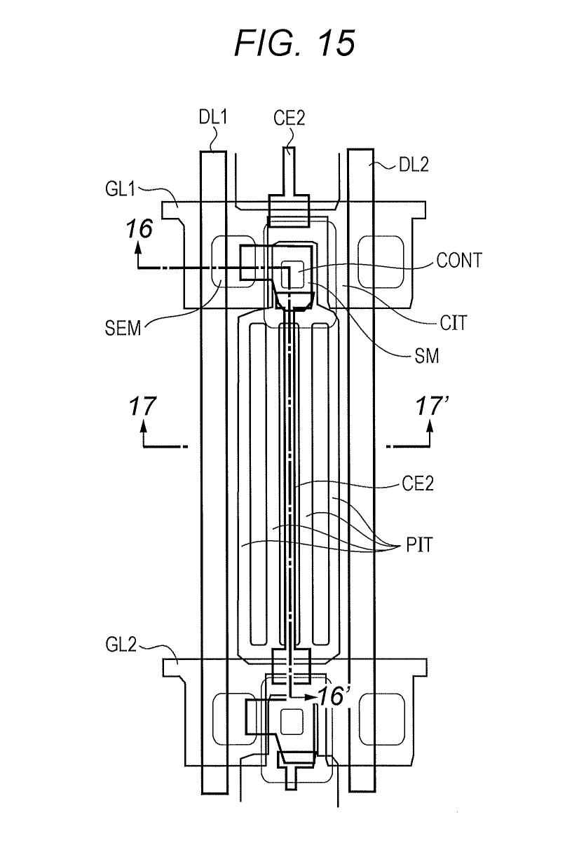

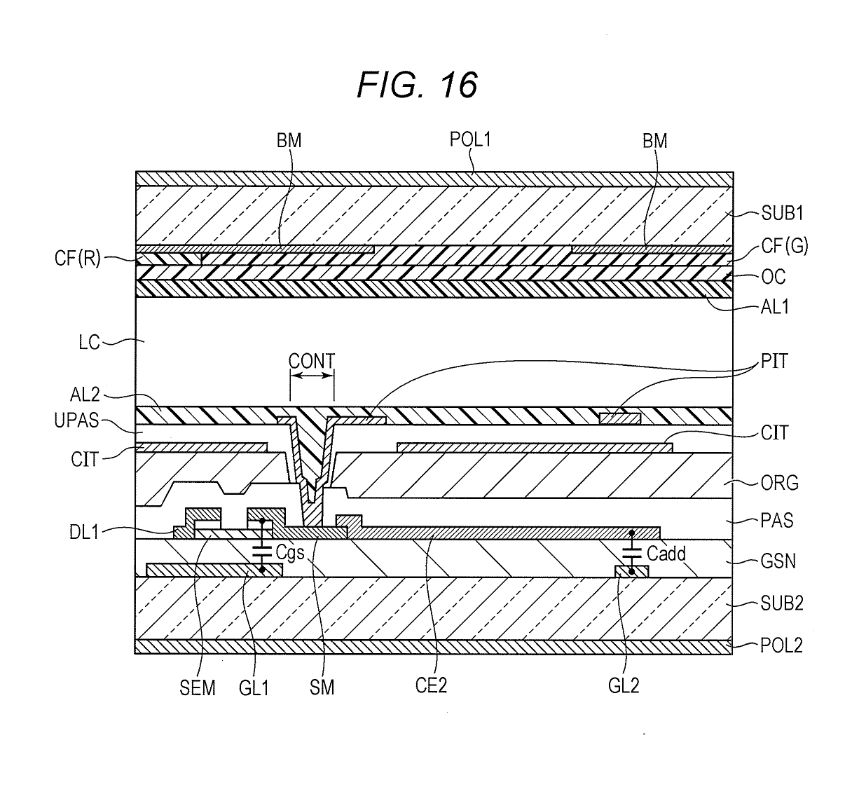

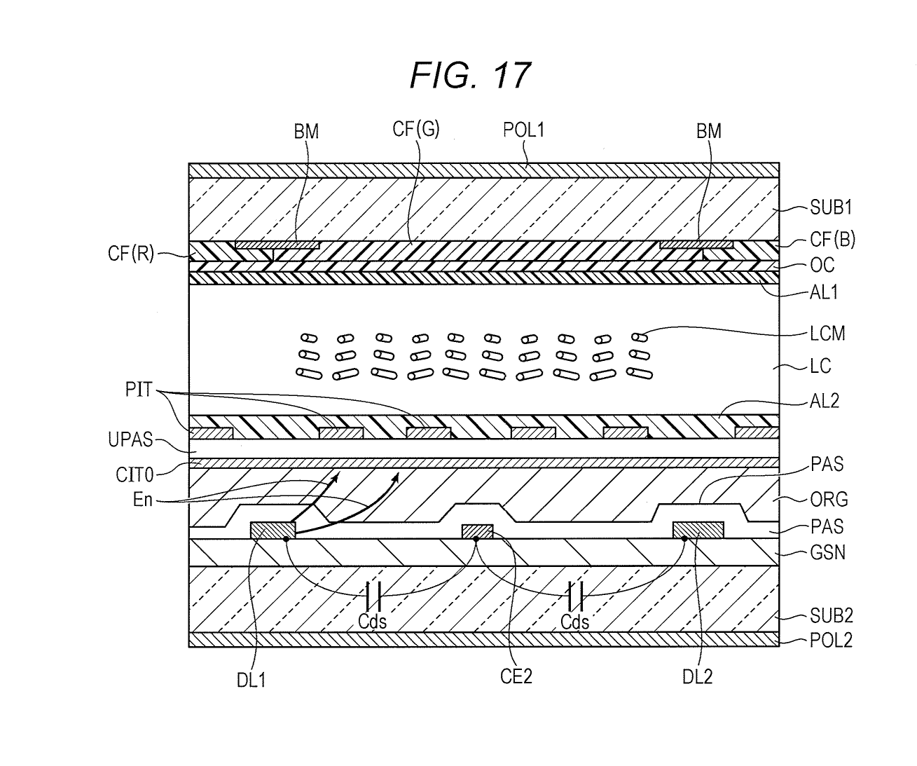

An entire configuration of a liquid crystal display device LCD according to a second exemplary embodiment is identical to that in FIG. 1. FIG. 15 is a plan view illustrating a configuration of one pixel in the liquid crystal display panel of the second exemplary embodiment, FIG. 16 is a sectional view taken along a line 16-16′ of FIG. 15, and FIG. 17 is a sectional view taken along a line 17-17′ of FIG. 15.

A capacitance electrode CE2 is disposed between (particularly, near the center of) the data signal lines DL1 and DL2 adjacent to each other, and extends in the column direction. As illustrated in FIG. 16, one of the ends of the capacitance electrode CE2 is laminated on the source electrode SM of the thin film transistor TFT. Therefore, the capacitance electrode CE2 is electrically connected to the source electrode SM, and electrically connected to the transparent pixel electrode PIT through the contact hole CONT. The other end of the capacitance electrode CE2 overlaps the next-stage gate signal line GL2 in plan view. Therefore, the additional capacitance Cadd is formed between the transparent pixel electrode PIT and the gate signal line GL2. The width of the capacitance electrode CE2 in the row direction is smaller than the distance between the end portion of the capacitance electrode CE2 and each of the data signal lines DL1 and DL2.

The capacitance electrode CE2 is made of a transparent conductive material. Therefore, the degradation of the aperture and transmittance can be prevented.

In the above pixel configuration, similarly to the first exemplary embodiment, the display unevenness caused by the parasitic capacitance Cgs generated in the gate signal line GL and the display unevenness caused by the parasitic capacitance Cds generated in the data signal line DL can simultaneously be reduced. The aperture and transmittance of the pixel can be improved compared with the first exemplary embodiment.

### Third Exemplary Embodiment

A third exemplary embodiment of the present disclosure will be described below with reference to the drawings. For convenience, the components having the same functions as those of the first exemplary embodiment are designated by the same reference marks, and their description is omitted.

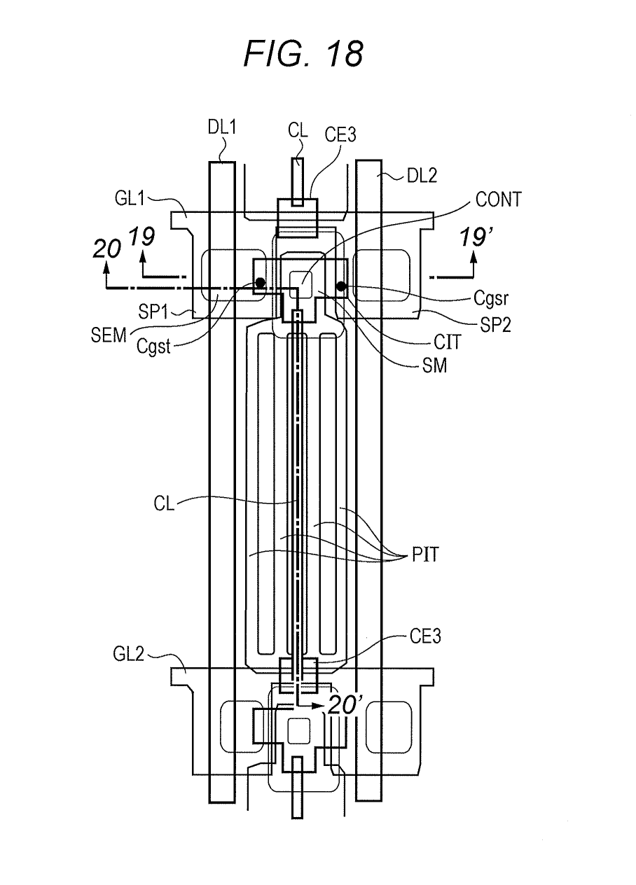

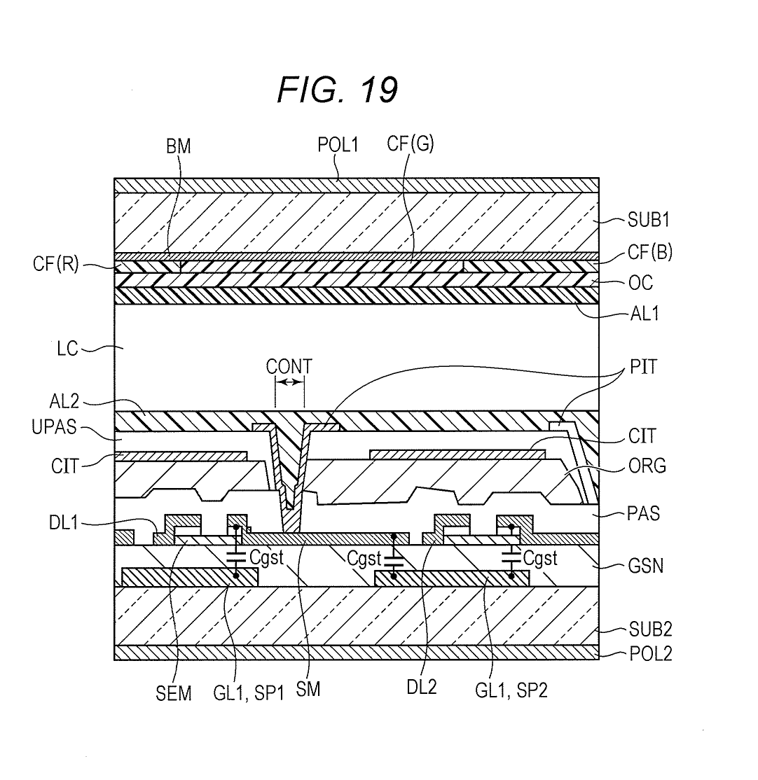

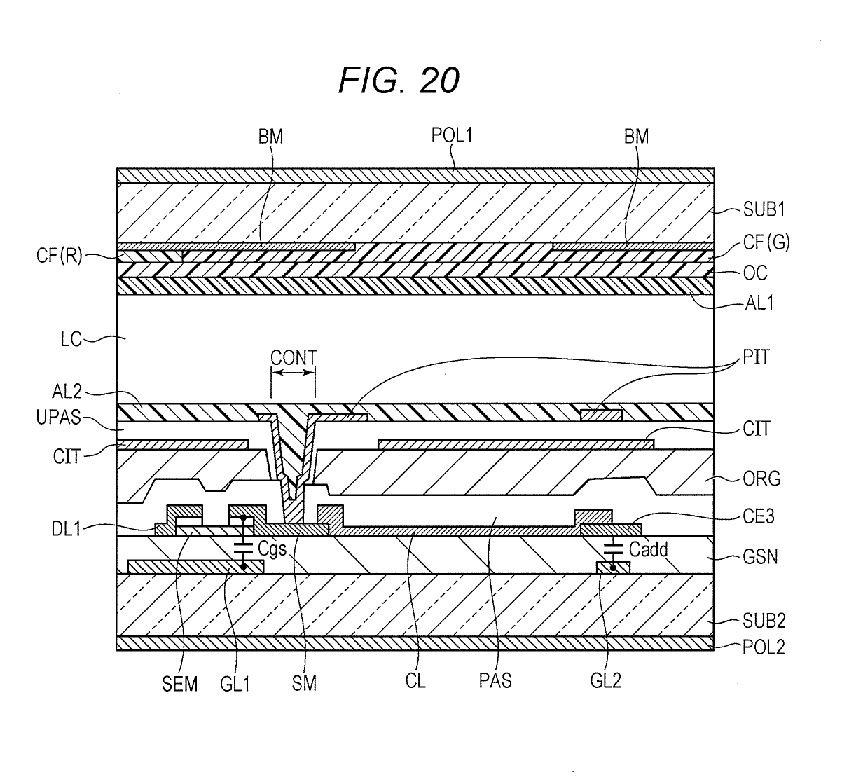

An entire configuration of a liquid crystal display device LCD according to a third exemplary embodiment is identical to that in FIG. 1. FIG. 18 is a plan view illustrating a configuration of one pixel in the liquid crystal display panel of the third exemplary embodiment, FIG. 19 is a sectional view taken along a line 19-19′ of FIG. 18, and FIG. 20 is a sectional view taken along a line 20-20′ of FIG. 18.

A capacitance electrode CE3 is formed into an island shape, and disposed between (particularly, near the center of) the data signal lines DL1 and DL2 adjacent to each other. The capacitance electrode CE3 overlaps the next-stage gate signal line GL2 in plan view. A coupling wiring CL extending in the column direction is formed near the center of the pixel region. One of the ends of the coupling wiring CL is laminated on the source electrode SM of the thin film transistor TFT, and the other end is laminated on the capacitance electrode CE3. Therefore, the capacitance electrode CE3 is electrically connected to the source electrode SM through the coupling wiring CL, and electrically connected to the transparent pixel electrode PIT through the contact hole CONT. The additional capacitance Cadd is formed between the transparent pixel electrode PIT and the gate signal line GL2. The width of the capacitance electrode CE3 in the row direction is smaller than the distance between the capacitance electrode CE3 and each of the data signal lines DL1 and DL2. Preferably the coupling wiring CL is made of a transparent conductive material. The capacitance electrode CE3 can be made of the same material as the source electrode SM through the same process.

In the above pixel configuration, similarly to the first exemplary embodiment, the display unevenness caused by the parasitic capacitance Cgs generated in the gate signal line GL and the display unevenness caused by the parasitic capacitance Cds generated in the data signal line DL can simultaneously be reduced. The aperture and transmittance of the pixel can be improved compared with the first exemplary embodiment.

As illustrated in FIG. 18, preferably the capacitance electrode CE3 overlaps the next-stage gate signal line GL2 so as to extend over the next-stage gate signal line GL2 in the column direction in plan view. Even if the capacitance electrode CE3 deviates in the vertical direction (column direction), the capacitance value of the additional capacitance Cadd can be kept constant because the area where the capacitance electrode CE3 and the gate signal line GL2 overlap each other does not fluctuate. Additionally, the capacitance value of the additional capacitance Cadd can be increased because the area where the capacitance electrode CE3 and the gate signal line GL2 overlap each other is enlarged.

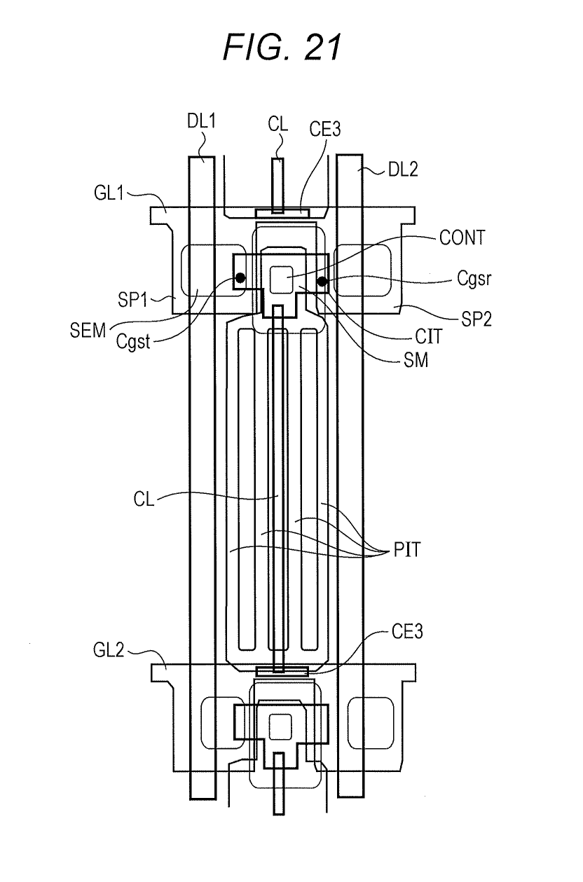

As illustrated in FIG. 21, the width of the capacitance electrode CE3 in the column direction may be smaller than the width of the gate signal line GL2 in the column direction, and may overlap the gate signal line GL2 so as to fall within the gate signal line GL2 in plan view. In this case, the width in the row direction of the capacitance electrode CE3 may be increased in order to increase the capacitance value of the additional capacitance Cadd. Therefore, the aperture and transmittance can be improved while the capacitance value of the additional capacitance Cadd is ensured.

As illustrated in FIGS. 18 and 19, the source electrode SM may extend in the row direction, and overlap the projections SP1 and SP2 so as to extend over the notch CP in plan view. Therefore, the capacitance Cgst is formed between the source electrode SM and the gate signal line GL1 (projection SP1), and a capacitance Cgsr is formed between the source electrode SM and the gate signal line GL1 (projection SP2). The capacitance Cgst and the capacitance Cgsr are included in the capacitance Cgs in FIG. 5.

In this configuration of the source electrode SM, even if the source electrode SM deviates in the horizontal direction (row direction), the capacitance Cgs can be kept constant because a sum of the capacitance Cgst and capacitance Cgsr does not change. Therefore, the fluctuation in jumping voltage ΔVsf is suppressed, so that the potential fluctuation in pixel potential Vs1 caused by a variation of the positional relationship between the gate signal line GL and the source electrode SM can be suppressed. This configuration of the source electrode SM can be used in the liquid crystal display devices LCD of the first and second exemplary embodiments.

Although exemplary embodiments of the present disclosure are described above, the present disclosure is not limited to these exemplary embodiments. It is noted that exemplary embodiments properly changed from the exemplary embodiments described above by those skilled in the art without departing from the scope of the present disclosure are included in the present disclosure.

What is claimed is:

1. A liquid crystal display device comprising:
a first substrate on a surface side;
a second substrate on a rear side;
a liquid crystal layer interposed between the first substrate and the second substrate; and
a plurality of gate signal lines, a plurality of data signal lines, a plurality of pixel electrodes, a common electrode, and a plurality of capacitance electrodes formed on the second substrate, wherein
the plurality of gate signal lines extend in a row direction,
the plurality of data signal lines extend in a column direction,
the plurality of pixel electrodes correspond to a plurality of pixels arrayed in the row and column directions,
the common electrode is disposed between the plurality of pixel electrodes and the second substrate,
the plurality of capacitance electrodes are disposed between the common electrode and the second substrate,
in each of the plurality of pixels, a capacitance electrode of the capacitance electrodes is electrically connected to a pixel electrode of the pixel electrodes disposed corresponding to the pixel,
at least a part of each of the capacitance electrodes overlaps a next-scanned gate signal line of the gate signal lines that is associated with an adjacent pixel of the pixels in plan view, and
the plurality of data signal lines and the plurality of capacitance electrodes overlap the common electrode in plan view.

2. The liquid crystal display device according to claim 1, further comprising a first insulating film covering the plurality of gate signal lines and being interposed between the gate signal lines and the capacitance electrodes.

3. The liquid crystal display device according to claim 2, further comprising:
a second insulating film; and
a third insulating film, wherein
the plurality of data signal lines and the plurality of capacitance electrodes are formed in a same layer,
the common electrode overlaps the pluralities of data signal lines and capacitance electrodes with the second insulating film being interposed therebetween, and
the plurality of pixel electrodes overlap the common electrode with the third insulating film being interposed therebetween.

4. The liquid crystal display device according to claim 3, wherein, in each of the plurality of pixels, the capacitance electrode is electrically connected to the pixel electrode corresponding to the pixel through a contact hole made in the second and third insulating films.

5. The liquid crystal display device according to claim 1, wherein, in each of the plurality of pixels, the capacitance electrode is disposed between an adjacent pair of the data signal lines, and extends in the column direction.

6. The liquid crystal display device according to claim 1, wherein, in each of the plurality of pixels, a width of the capacitance electrode in the row direction is smaller than a distance between the capacitance electrode and a data signal line of the data signal lines that is adjacent to the capacitance electrode.

7. The liquid crystal display device according to claim 1, wherein, in each of the plurality of pixels, the capacitance electrode overlaps the next-scanned gate signal line that is associated with the adjacent pixel so as to extend beyond at least part of the next-scanned gate signal line in the column direction in plan view.

8. The liquid crystal display device according to claim 1, further comprising a plurality of thin film transistors, each having a conduction electrode, that are disposed near intersection points of the pluralities of data signal lines and gate signal lines,
wherein, in each of the plurality of pixels, the conduction electrode of a thin film transistor of the thin film transistors corresponding to the pixel extends to form the capacitance electrode.

9. The liquid crystal display device according to claim 1, further comprising a plurality of thin film transistors, each having a conduction electrode, that are disposed near intersection points of the pluralities of data signal lines and gate signal lines,
wherein, in each of the plurality of pixels, the capacitance electrode is electrically connected to the conduction electrode of a thin film transistor of the thin film transistors corresponding to the pixel.

10. The liquid crystal display device according to claim 9, wherein the plurality of capacitance electrodes are made of a transparent conductive material.

11. The liquid crystal display device according to claim 1, further comprising a plurality of thin film transistors, each having a conduction electrode, that are disposed near intersection points of the pluralities of data signal lines and gate signal lines, wherein
in plan view, each of the plurality of gate signal lines includes a notch, a first projection, and a second projection in each of the plurality of pixels, the notch accommodating a contact hole therein, the first and second projections being disposed in the row direction while facing each other with the notch being interposed therebetween, and
in each of the plurality of pixels, the conduction electrode of a thin film transistor of the thin film transistors overlaps the first and second projections while extending over the notch in plan view.

12. A liquid crystal display device production method comprising the steps of:
forming a gate signal line on a substrate;
forming a first insulating film to cover the gate signal line;
forming a data signal line on the first insulating film;
forming a capacitance electrode on the first insulating film such that at least a part of the capacitance electrode overlaps the gate signal line that is adjacent in a scan direction in plan view;
forming a second insulating film to cover the data signal line and the capacitance electrode;
forming a common electrode on the second insulating film;
forming a third insulating film to cover the common electrode;
forming a contact hole in the second and third insulating films; and
forming a pixel electrode on the third insulating film and in the contact hole.
